(19) United States
(12) Patent Application Publication
(10) Pub. No.: US 2025/0125923 A1
(43) Pub. Date: Apr. 17, 2025

(54) USER EQUIPMENT AND NETWORK NODE COORDINATION

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/488,695

(22) Filed: Oct. 17, 2023

(51) Int. Cl. H04L 5/00; H04B 7/0456; H04W 8/24; H04W 24/10

(52) U.S. Cl. CPC H04L 5/0051; H04B 7/0456; H04W 8/24; H04W 24/10

(57) ABSTRACT

Various aspects of the present disclosure generally relate to wireless communication. In some aspects, a user equipment (UE) may transmit capability information associated with performing reciprocity-based communications, the reciprocity-based communications being in accordance with one or more sounding reference signals associated with one or more ports. The UE may receive, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements. Numerous other aspects are described.

### FIELD OF THE DISCLOSURE

Aspects of the present disclosure generally relate to wireless communication and to techniques and apparatuses for user equipment and network node coordination.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes transmitting capability information associated with performing reciprocity-based communications, the reciprocity-based communications being in accordance with one or more sounding reference signals associated with one or more ports; and receiving, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, a method of wireless communication performed by a network node includes receiving capability information associated with a UE performing reciprocity-based communications, the reciprocity-based communications being in accordance with one or more sounding reference signals associated with one or more ports; and transmitting, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, a method of wireless communication performed by a UE includes transmitting capability information that indicates a plurality of operating modes supported by the UE, the plurality of operating modes being in accordance with at least one of a location of the UE, a network performance indicator, a power savings indicator, or one or more applications associated with the UE; and receiving, in accordance with transmitting the capability information, configuration information associated with one or more operating modes of the plurality of operating modes supported by the UE.

In some aspects, a method of wireless communication performed by a network node includes receiving capability information that indicates a plurality of operating modes supported by a UE, the plurality of operating modes being in accordance with at least one of a location of the UE, a network performance indicator, a power savings indicator, or one or more applications associated with the UE; and transmitting, in accordance with receiving the capability information, configuration information associated with one or more operating modes of the plurality of operating modes supported by the UE.

In some aspects, an apparatus for wireless communication at a UE includes one or more memories; and one or more processors, coupled to the one or more memories, which are configured, individually or in any combination, to cause the UE to: transmit capability information associated with performing reciprocity-based communications, the reciprocity-based communications being in accordance with one or more sounding reference signals associated with one or more ports; and receive, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, an apparatus for wireless communication at a network node includes one or more memories; and one or more processors, coupled to the one or more memories, which are configured, individually or in any combination, to cause the network node to: receive capability information associated with a UE performing reciprocity-based communications, the reciprocity-based communications being in accordance with one or more sounding reference signals associated with one or more ports; and transmit, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, an apparatus for wireless communication at a UE includes one or more memories; and one or more processors, coupled to the one or more memories, which are configured, individually or in any combination, to cause the UE to: transmit capability information that indicates a plurality of operating modes supported by the UE, the plurality of operating modes being in accordance with at least one of a location of the UE, a network performance indicator, a power savings indicator, or one or more applications associated with the UE; and receive, in accordance with transmitting the capability information, configuration information associated with one or more operating modes of the plurality of operating modes supported by the UE.

In some aspects, an apparatus for wireless communication at a network node includes one or more memories; and one or more processors, coupled to the one or more memories, which are configured, individually or in any combination, to cause the network node to: receive capability information that indicates a plurality of operating modes supported by a UE, the plurality of operating modes being in accordance with at least one of a location of the UE, a network performance indicator, a power savings indicator, or one or more applications associated with the UE; and transmit, in accordance with receiving the capability information, configuration information associated with one or more operating modes of the plurality of operating modes supported by the UE.

In some aspects, a non-transitory computer-readable medium storing a set of instructions for wireless communication includes one or more instructions that, when executed by one or more processors of a UE, cause the UE to: transmit capability information associated with performing reciprocity-based communications, the reciprocity-based communications being in accordance with one or more sounding reference signals associated with one or more ports; and receive, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, a non-transitory computer-readable medium storing a set of instructions for wireless communication includes one or more instructions that, when executed by one or more processors of a network node, cause the network node to: receive capability information associated with a UE performing reciprocity-based communications, the reciprocity-based communications being in accordance with one or more sounding reference signals associated with one or more ports; and transmit, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, a non-transitory computer-readable medium storing a set of instructions for wireless communication includes one or more instructions that, when executed by one or more processors of a UE, cause the UE to: transmit capability information that indicates a plurality of operating modes supported by the UE, the plurality of operating modes being in accordance with at least one of a location of the UE, a network performance indicator, a power savings indicator, or one or more applications associated with the UE; and receive, in accordance with transmitting the capability information, configuration information associated with one or more operating modes of the plurality of operating modes supported by the UE.

In some aspects, a non-transitory computer-readable medium storing a set of instructions for wireless communication includes one or more instructions that, when executed by one or more processors of a network node, cause the network node to: receive capability information that indicates a plurality of operating modes supported by a UE, the plurality of operating modes being in accordance with at least one of a location of the UE, a network performance indicator, a power savings indicator, or one or more applications associated with the UE; and transmit, in accordance with receiving the capability information, configuration information associated with one or more operating modes of the plurality of operating modes supported by the UE.

In some aspects, an apparatus for wireless communication includes means for transmitting capability information associated with performing reciprocity-based communications, the reciprocity-based communications being in accordance with one or more sounding reference signals associated with one or more ports; and means for receiving, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, an apparatus for wireless communication includes means for receiving capability information associated with a UE performing reciprocity-based communications, the reciprocity-based communications being in accordance with one or more sounding reference signals associated with one or more ports; and means for transmitting, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, an apparatus for wireless communication includes means for transmitting capability information that indicates a plurality of operating modes supported by the UE, the plurality of operating modes being in accordance with at least one of a location of the UE, a network performance indicator, a power savings indicator, or one or more applications associated with the UE; and means for receiving, in accordance with transmitting the capability information, configuration information associated with one or more operating modes of the plurality of operating modes supported by the UE.

In some aspects, an apparatus for wireless communication includes means for receiving capability information that indicates a plurality of operating modes supported by a UE, the plurality of operating modes being in accordance with at least one of a location of the UE, a network performance indicator, a power savings indicator, or one or more applications associated with the UE; and means for transmitting, in accordance with receiving the capability information, configuration information associated with one or more operating modes of the plurality of operating modes supported by the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of UE and network node communication modes, in accordance with the present disclosure.

FIG. 6 is a diagram illustrating an example of UE and network node coordination, in accordance with the present disclosure.

FIG. 7 is a diagram illustrating an example of UE and network node coordination, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

A user equipment (UE) may be configured to communicate with a network node. The UE and the network node may communicate using one or more communication types and/or using one or more operating modes (e.g., smart modes). In a first example, the UE and the network node may be configured to communicate using codebook-based communications or using reciprocity-based communications. Codebook-based communications may be in accordance with one or more channel state information (CSI) reports transmitted by the UE to the network node. For example, the codebook-based communications may be (or may include) channel quality indicators (CQIs), precoding matrix indicators (PMIs), and/or rank indicators (RIs). In contrast, reciprocity-based communications may be in accordance with sounding reference signal (SRS) transmissions by the UE to the network node. For example, the network node may receive an SRS from the UE and may estimate a channel and derive a precoder in accordance with the SRS. In some cases, reciprocity-based communications may offer improved performance compared to codebook-based communications, for example, provided that an SRS is received at the network node with a signal-to-noise ratio (SNR) that satisfies a threshold. Alternatively, if the SNR does not satisfy the threshold, codebook-based communications may enable improved performance compared to reciprocity-based communications. In some cases, an optimal switching point (e.g., a slot for switching between codebook-based communications and reciprocity-based communications) may be identified in accordance with a path loss, for example, since the UE is likely to be transmitting using a full transmission power at the switching point. However, the network node may be configured to switch between codebook-based communications and reciprocity-based communications without input from the UE. This may result in reduced communication performance between the UE and the network node. For example, this may result in reduced communication performance when codebook-based transmissions are performed when an SRS satisfies the SNR threshold, or when reciprocity-based transmissions are performed when the SRS does not satisfy the SNR threshold.

In a second example, the UE may be configured to activate one or more communication modes (e.g., operating modes or smart modes) of the UE. In some cases, the one or more communication modes may be based at least in part on a location of the UE, a network performance indicator, a power savings indicator, or one or more applications associated with the UE (e.g., one or more applications operating on the UE). For example, the one or more communication modes may be based at least in part on one or more conditions, such as whether the UE is on a subway, on a high-speed train, in a home, in an office, at an indoor location, at an outdoor location, in an elevator, in a high-network load scenario, in a light-network load scenario, in a high-interference scenario, in a low-interference scenario, or whether a particular application is operating on the UE, among other examples. Each communication mode of the one or more communication modes may be configured to enhance a user experience, reduce a UE power consumption, and/or reduce a network load in accordance with one or more conditions experienced by the UE. In some cases, the one or more communication modes may include a combination of communication modes. For example, the UE may activate a first communication mode in accordance with being located on a high-speed train, may activate a second communication mode in accordance with a first application operating on the UE, or may activate a third communication mode (or a combination of features from the first communication mode and the second communication mode) in accordance with the UE being located on a high-speed train and the first application operating on the UE. In some cases, the UE may activate (e.g., autonomously activate) a communication mode in accordance with detecting one or more conditions. However, the UE may not be configured to transmit an indication to the network node that indicates the activation of the communication mode. This may result in reduced communication performance between the UE and the network node. For example, this may result in the network node communicating with the UE using one or more communication parameters that are not optimized for the communication mode that is currently activated by the UE.

Various aspects relate generally to wireless communications. Some aspects more specifically relate to UE and network node coordination. In some aspects, a UE may transmit, and a network node may receive, capability information associated with performing reciprocity-based communications. The reciprocity-based communications may include one or more sounding reference signal transmissions associated with one or more ports. The UE may receive, from the network node, at least one of an indication to perform reciprocity-based communications, an indication to perform codebook-based communications, or an indication to perform a combination of reciprocity-based communications and codebook-based communications. The codebook-based communications may be based at least in part on one or more channel state information measurements performed by the UE. In some examples, receiving the indication to perform reciprocity-based communications, the indication to perform codebook-based communications, or the indication to perform the combination of reciprocity-based communications and codebook-based communications may include receiving a plurality of bits, where a first value of the plurality of bits indicates to perform reciprocity-based communications, a second value of the plurality of bits indicates to perform codebook-based communications, and a third value of the plurality of bits indicates to perform the combination of reciprocity-based communications and codebook-based communications. In some examples, the UE may transmit, and the network node may receive, a reciprocity indicator that indicates a similarity between an uplink channel and a downlink channel. The UE may transmit the reciprocity indicator periodically (e.g., in accordance with an interval) or aperiodically (e.g., in accordance with an occurrence of an event). In some examples, the UE and the network node may perform codebook-based communications in accordance with the reciprocity indicator having a value that is less than a first threshold, perform reciprocity-based communications in accordance with the reciprocity indicator having a value that is greater than a second threshold, or perform the combination of codebook-based communications and reciprocity-based communications in accordance with the reciprocity indicator having a value that is greater than or equal to the first threshold and less than or equal to the second threshold. In some other aspects, the UE may transmit, and the network node may receive, capability information that indicates a plurality of operating modes (e.g., smart modes) supported by the UE, the plurality of operating modes being in accordance with at least one of a location of the UE, a network performance indicator, a power savings indicator, or one or more applications associated with the UE. The network node may transmit, and the UE may receive, configuration information associated with one or more operating modes of the plurality of operating modes supported by the UE. For example, the network node may identify one or more operating modes that are supported by the network node, and may transmit an indication for the UE to enable the one or more operating modes that are supported by the network node.

Particular aspects of the subject matter described in this disclosure can be implemented to realize one or more of the following potential advantages. In some examples, by communicating information that indicates to perform reciprocity-based communications, codebook-based communications, or a combination of reciprocity-based communications and codebook-based communications, the described techniques can be used to enable UE and network coordination to select a downlink transmission scheme (e.g., reciprocity-based or codebook-based) in accordance with one or more UE characteristics and/or network characteristics, which may reduce UE power consumption and/or reduce network resource consumption. For example, the described techniques may reduce CSI measurements by the UE in accordance with the UE performing reciprocity-based communications and/or may reduce SRS transmissions by the UE in accordance with the UE performing codebook-based communications. In some examples, by communicating information associated with one or more operating modes supported by the UE, the described techniques can be used to reduce UE power consumption, reduce network resource consumption, and/or improve a spectral efficiency. For example, the described techniques can be used to enable the UE to activate one or more smart modes in accordance with network node capability information, and to communicate with the network node using the one or more smart modes, which may improve a user experience and may result in reduced UE power consumption and increased performance gain. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

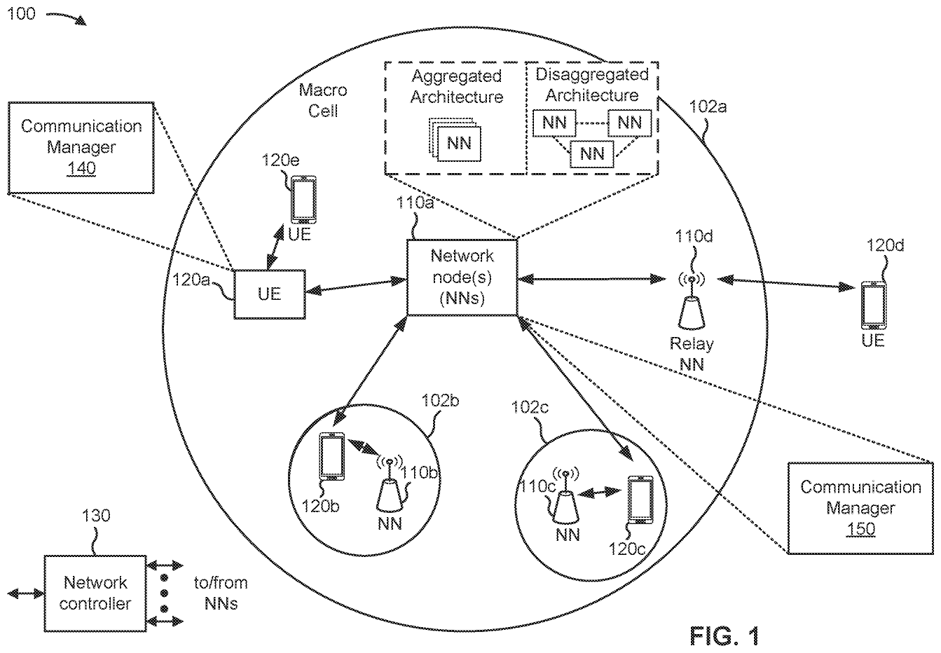

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. In some aspects, as described in more detail elsewhere herein, the communication manager 140 may transmit capability information associated with performing reciprocity-based communications, the reciprocity-based communications being in accordance with one or more sounding reference signals associated with one or more ports; and receive, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements. In some other aspects, as described in more detail elsewhere herein, the communication manager 140 may transmit capability information that indicates a plurality of operating modes supported by the UE 120, the plurality of operating modes being in accordance with at least one of a location of the UE 120, a network performance indicator, a power savings indicator, or one or more applications associated with the UE 120; and receive, in accordance with transmitting the capability information, configuration information associated with one or more operating modes of the plurality of operating modes supported by the UE 120. Additionally, or alternatively, the communication manager 140 may perform one or more other operations described herein.

In some aspects, the network node 110 may include a communication manager 150. In some aspects, as described in more detail elsewhere herein, the communication manager 150 may receive capability information associated with UE performing reciprocity-based communications, the reciprocity-based communications being in accordance with one or more sounding reference signals associated with one or more ports; and transmit, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements. In some other aspects, as described in more detail elsewhere herein, the communication manager 150 may receive capability information that indicates a plurality of operating modes supported by a UE, the plurality of operating modes being in accordance with at least one of a location of the UE, a network performance indicator, a power savings indicator, or one or more applications associated with the UE; and transmit, in accordance with receiving the capability information, configuration information associated with one or more operating modes of the plurality of operating modes supported by the UE. Additionally, or alternatively, the communication manager 150 may perform one or more other operations described herein.

As indicated above, FIG. 1 is provided as an example. Other examples may differ from what is described with regard to FIG. 1.

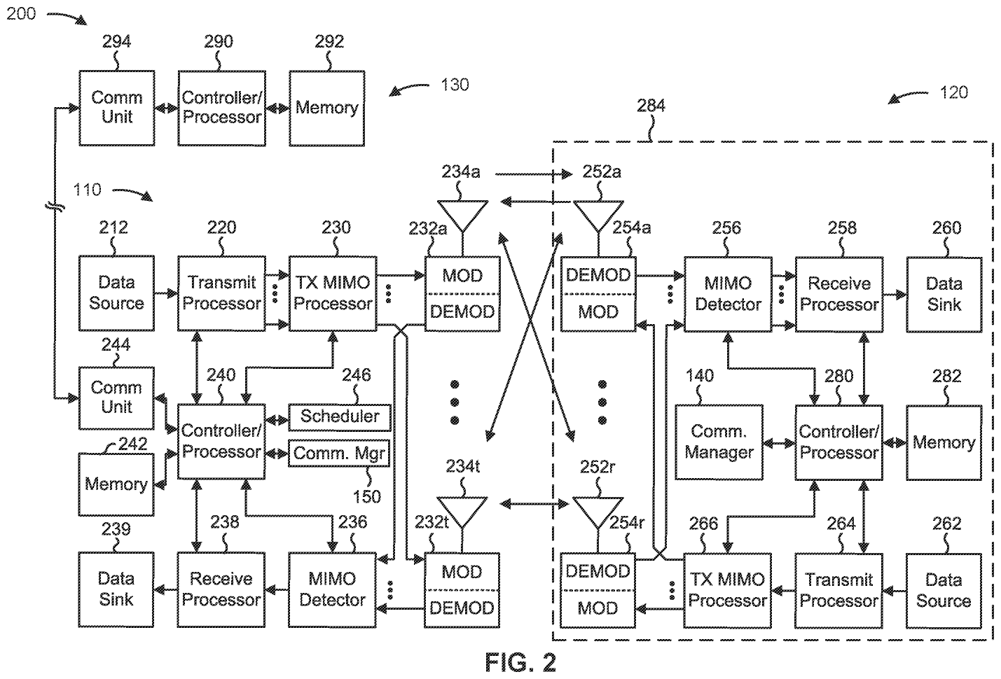

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

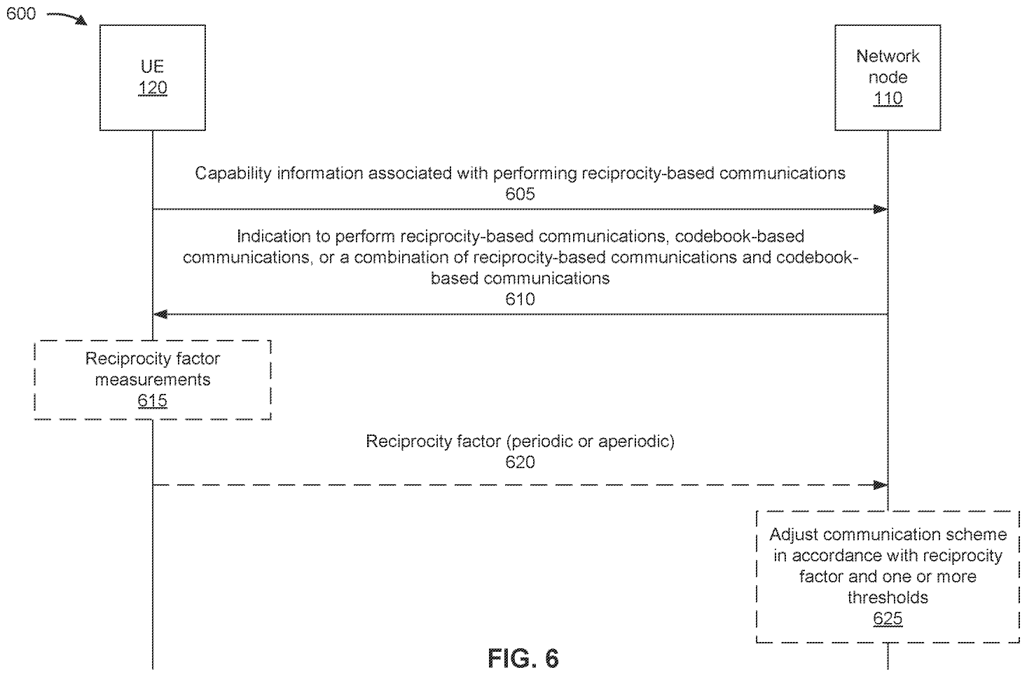

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

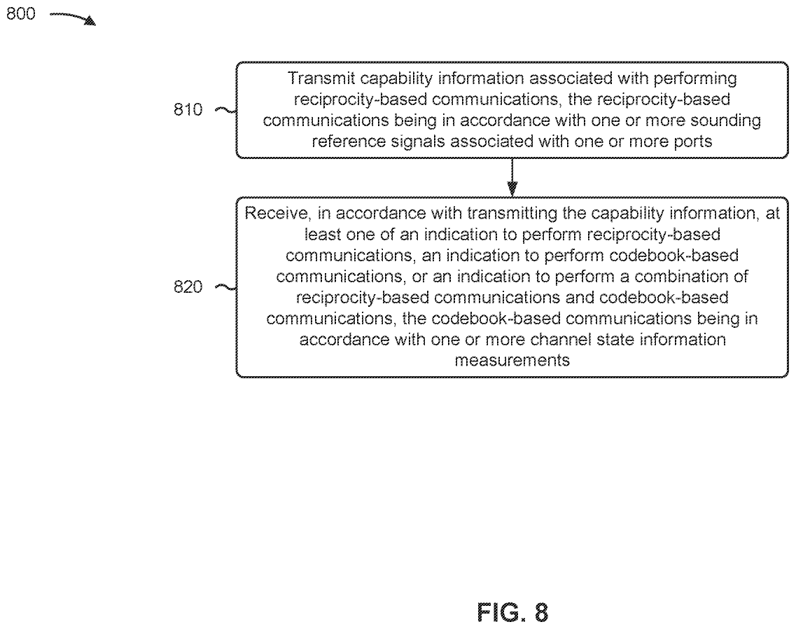

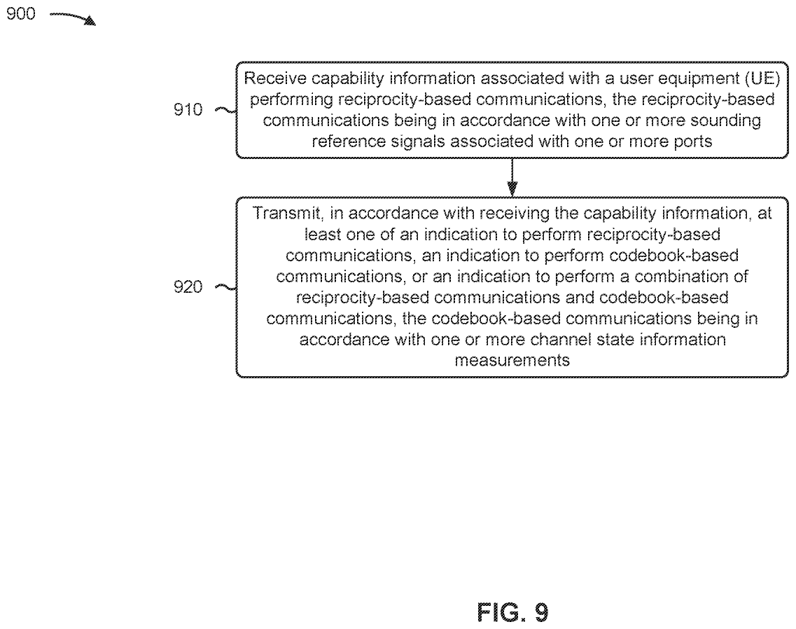

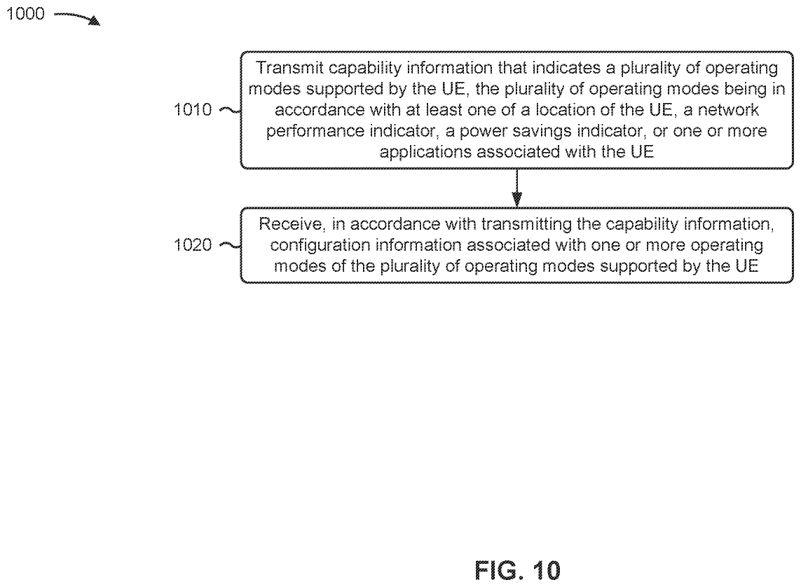

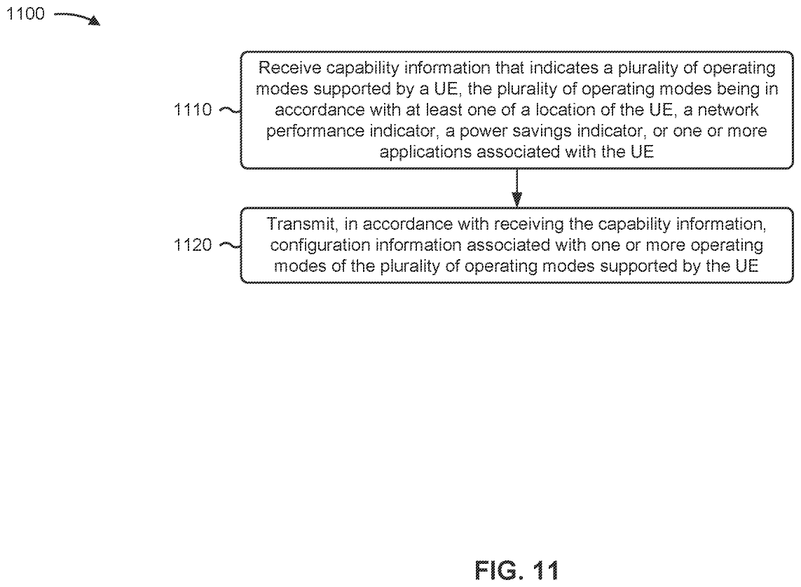

The controller/processor 240 of the network node 110, the controller/processor 280 of the UE 120, and/or any other component(s) of FIG. 2 may perform one or more techniques associated with UE and network node coordination, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for transmitting capability information associated with performing reciprocity-based communications, the reciprocity-based communications being in accordance with one or more sounding reference signals associated with one or more ports; and/or means for receiving, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, the UE 120 includes means for transmitting capability information that indicates a plurality of operating modes supported by the UE, the plurality of operating modes being in accordance with at least one of a location of the UE, a network performance indicator, a power savings indicator, or one or more applications associated with the UE; and/or means for receiving, in accordance with transmitting the capability information, configuration information associated with one or more operating modes of the plurality of operating modes supported by the UE. The means for UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving capability information associated with a UE performing reciprocity-based communications, the reciprocity-based communications being in accordance with one or more sounding reference signals associated with one or more ports; and/or means for transmitting, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

In some aspects, the network node 110 includes means for receiving capability information that indicates a plurality of operating modes supported by a UE, the plurality of operating modes being in accordance with at least one of a location of the UE, a network performance indicator, a power savings indicator, or one or more applications associated with the UE; and/or means for transmitting, in accordance with receiving the capability information, configuration information associated with one or more operating modes of the plurality of operating modes supported by the UE. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

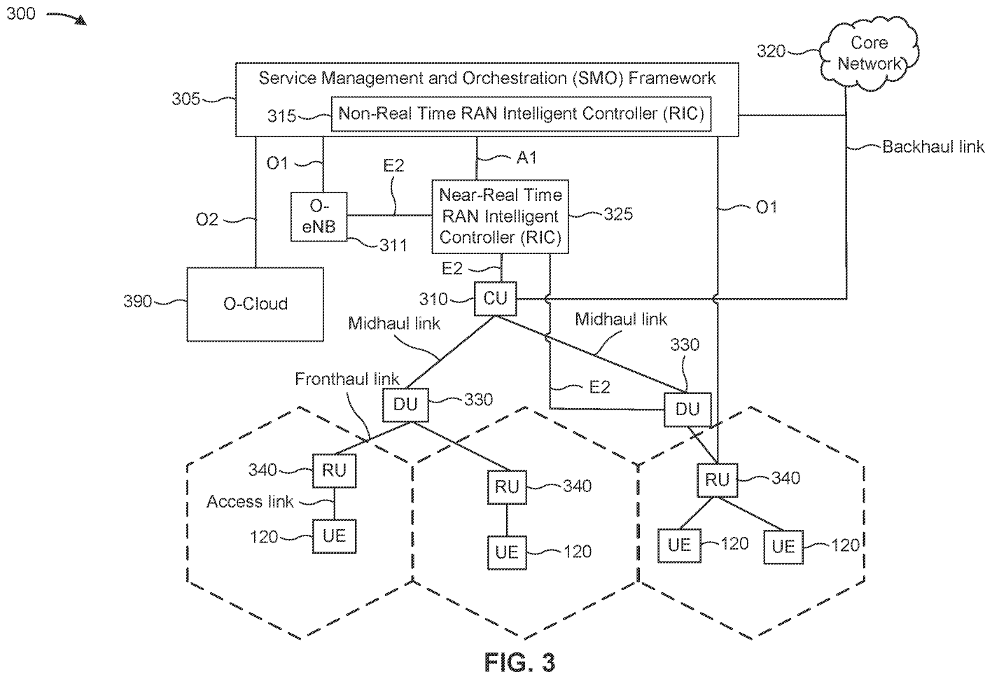

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

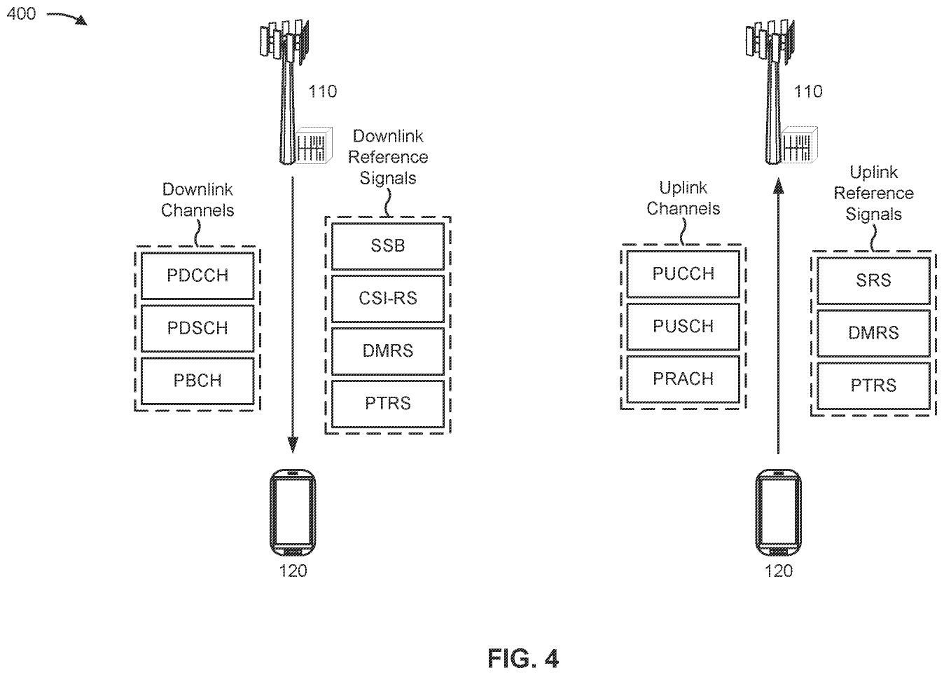

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

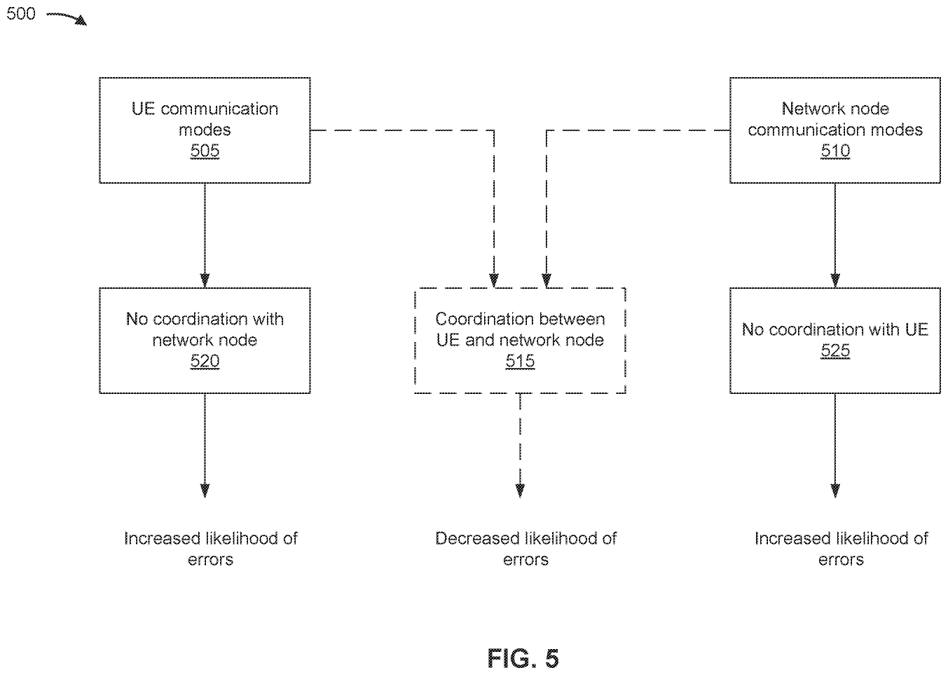

FIG. 5 is a diagram illustrating an example 500 of UE and network node communication modes, in accordance with the present disclosure.

In some cases, the UE 120 may be configured to communicate with the network node 110 using one or more communication modes of a plurality of UE communication modes 505. For example, the UE 120 may be configured to receive a first type of downlink communication from the network node 110 using a first communication mode and/or may be configured to receive a second type of downlink communication from the network node 110 using a second communication mode. Additionally, or alternatively, the UE 120 may be configured to communicate with the network node 110 in accordance with one or more operating modes (e.g., smart modes) of the UE 120. In some cases, the network node 110 may be configured to communicate with the UE 120 using one or more communication modes of a plurality of network node communication modes 510. For example, the network node 110 may be configured to transmit a first type of downlink communication to the UE 120 using a first communication mode and/or may be configured to transmit a second type of downlink communication to the UE 120 using a second communication mode. Additionally, or alternatively, the network node 110 may be configured to communicate with the UE 120 in accordance with the one or more operating modes of the network node 110. As shown by reference number 515, coordination between the UE 120 and the network node 110 regarding the communication modes may result in a decreased likelihood of communication errors during communications between the UE 120 and the network node 110. However, in some cases, the UE 120 and the network node 110 may not be configured to coordinate information that indicates a respective communication mode being used by the UE 120 or the network node 110. For example, as shown by reference number 520, the UE 120 may not be configured to transmit information to the network node 110 that indicates a current communication mode of the UE 120. Additionally, or alternatively, as shown by reference number 525, the network node 110 may not be configured to transmit information to the UE 120 that indicates a current communication mode of the network node 110. This may result in an increased likelihood of communication errors during communications between the UE 120 and the network node 110.

In a first example, the UE 120 and the network node 110 may be configured to communicate using codebook-based communications or using reciprocity-based communications. Codebook-based communications may be in accordance with one or more CSI reports transmitted by the UE 120 to the network node 110. For example, the codebook-based communications may be (or may include) CQIs, PMIs, and/or RIs. In contrast, reciprocity-based communications may be in accordance with SRS transmissions by the UE 120 to the network node 110. For example, the network node 110 may receive an SRS from the UE 120 and may estimate a channel and derive a precoder in accordance with the SRS. In some cases, reciprocity-based communications may offer improved performance compared to codebook-based communications, for example, provided that an SRS is received at the network node 110 with an SNR that satisfies a threshold. Alternatively, if the SNR does not satisfy the threshold, codebook-based communications may enable improved performance compared to reciprocity-based communications. In some cases, an optimal switching point (e.g., a slot for switching between codebook-based communications and reciprocity-based communications) may be identified in accordance with a path loss, for example, since the UE 120 is likely to be transmitting using a full transmission power at the switching point. However, the network node 110 may be configured to switch between codebook-based communications and reciprocity-based communications without input from the UE 120. This may result in reduced communication performance between the UE 120 and the network node 110. For example, this may result in reduced communication performance when codebook-based transmissions are performed when an SRS satisfies the SNR threshold, or when reciprocity-based transmissions are performed when the SRS does not satisfy the SNR threshold.

In a second example, the UE 120 may be configured to activate one or more communication modes (e.g., smart modes) of the UE 120. In some cases, the one or more communication modes may be based at least in part on a location of the UE 120, a network performance indicator, a power savings indicator, or one or more applications associated with the UE 120 (e.g., one or more applications operating on the UE 120). For example, the one or more communication modes may be based at least in part on one or more conditions, such as whether the UE 120 is in a subway, on a high-speed train, in a home, in an office, at an indoor location, at an outdoor location, in an elevator, in a high-network load scenario, in a light-network load scenario, in a high-interference scenario, in a low-interference scenario, or whether a particular application is operating on the UE, among other examples. Each communication mode of the one or more communication modes may be configured to enhance a user experience, reduce a UE power consumption, and/or reduce a network load in accordance with one or more conditions being experienced by the UE 120. In some cases, the one or more communication modes may include a combination of communication modes. For example, the UE 120 may be configured to activate a first communication mode in accordance with being located on a high-speed train, to activate a second communication mode in accordance with a first application operating on the UE 120, or to activate a third communication mode (or a combination of features from the first communication mode and the second communication mode) in accordance with the UE 120 being located on a high-speed train and the first application operating on the UE 120. In some cases, the UE 120 may activate (e.g., autonomously activate) a communication mode in accordance with detecting one or more conditions. However, the UE 120 may not be configured to transmit an indication to the network node 110 that indicates the activation of the communication mode. This may result in reduced communication performance between the UE 120 and the network node 110. For example, this may result in the network node 110 communicating with the UE 120 using one or more communication parameters that are not optimized for the communication mode activated by the UE 120.

As indicated above, FIG. 5 is provided as an example. Other examples may differ from what is described with regard to FIG. 5.

FIG. 6 is a diagram illustrating an example 600 of UE and network node coordination, in accordance with the present disclosure.

As shown by reference number 605, the UE 120 may transmit, and the network node 110 may receive, capability information associated with performing reciprocity-based communications. In some aspects, the UE 120 may perform reciprocity-based communications in accordance with transmitting one or more SRSs. The network node 110 may receive the one or more SRSs from the UE 120, and may use the one or more SRSs to estimate a channel between the network node 110 and the UE 120 and/or to derive an optimal precoder for communications between the network node 110 and the UE 120. In some aspects, performing reciprocity-based communications may include reducing a quantity of CSI measurements performed by the UE 120. For example, the UE 120, in accordance with performing reciprocity-based communications, may switch from transmitting CSI measurements every 10 milliseconds (ms) to transmitting CSI measurements every 40 ms.

As shown by reference number 610, the network node 110 may transmit, and the UE 120 may receive, an indication to perform reciprocity-based communications, an indication to perform codebook-based communications, or an indication to perform a combination of reciprocity-based communications and codebook-based communications. In some aspects, the UE 120 may perform codebook-based communications in accordance with performing one or more CSI measurements. For example, the UE 120 may transmit a CSI measurement in accordance with receiving an indication to perform reciprocity-based communications, where transmitting the CSI measurement includes transmitting a CSI, a PMI, an RI, and/or a reciprocity factor associated with an uplink channel and a downlink channel between the UE 120 and the network node 110. In some aspects, performing codebook-based communications may include reducing a frequency of SRS transmissions by the UE 120. In some aspects, receiving the indication to perform the reciprocity-based communications, the codebook-based communications, or the combination of reciprocity-based communications and codebook-based communications may include receiving a plurality of bits. For example, the network node 110 may transmit, and the UE 120 may receive, a plurality of bits (e.g., two bits), where a first value of the bits (e.g., 00) indicates to perform the reciprocity-based communications, a second value of the bits (e.g., 01) indicates to perform the codebook-based communications, and a third value of the bits (e.g., 10) indicates to perform the combination of the reciprocity-based communications and the codebook-based communications.

As shown by reference number 615, the UE 120 may perform one or more reciprocity factor measurements. For example, the UE 120 may measure a downlink reference signal, such as a synchronization signal block (SSB) and/or a CSI reference signal (CSI-RS), and may identify a reciprocity factor in accordance with the downlink reference signal measurement(s). In some aspects, the UE 120 may measure a distance between the UE 120 and the network node 110, a path loss associated with the UE 120 and the network node 110, and/or other factors associated with a performance of reciprocity-based communications or codebook-based communications. For example, the UE 120 may measure a UE and network node transmission chain timing difference, and/or may measure a different UE chain timing difference.

As shown by reference number 620, the UE 120 may transmit, and the network node 110 may receive, the reciprocity factor. The reciprocity factor may indicate a switching point, such as a switching point for switching between reciprocity-based communications and codebook-based communications. For example, the reciprocity factor may indicate one or more slots for switching between reciprocity-based communications and codebook-based communications. In some aspects, transmitting the reciprocity factor may include transmitting an RRC message (Layer 3), a MAC control element (MAC-CE) (Layer 2), or CSI (Layer 1) that includes the reciprocity factor. In some aspects, the reciprocity factor may include a downlink RSRP measurement, or may be included in a communication that also includes a downlink RSRP measurement. The reciprocity factor may be transmitted periodically or aperiodically. For example, the UE 120 may transmit the reciprocity factor in accordance with an interval (e.g., every 20 milliseconds). Additionally, or alternatively, the reciprocity factor may be transmitted based at least in part on an occurrence of an event, such as a change to network conditions.

As shown by reference number 625, the network node 110 may adjust a communication scheme in accordance with the reciprocity factor. For example, the network node 110 may adjust a multiple-input multiple-output (MIMO) communication scheme in accordance with the reciprocity factor. In some aspects, the network node 110 may receive the reciprocity factor (and/or the SRS) from the UE 120 and may switch between reciprocity-based communications or codebook-based communications in accordance with one or more thresholds. For example, the network node 110 may enable and/or switch to codebook-based communications (such as PMI-based downlink MIMO communications) in accordance with the reciprocity factor having a value that is less than a first threshold, may enable and/or switch to reciprocity-based communications (such as SRS-based downlink MIMO communications) in accordance with the reciprocity factor having a value that is greater than a second threshold, or may enable and/or switch to a combination of reciprocity-based communications and codebook-based communications (e.g., joint-PMI-and-SRS-based downlink MIMO communications) in accordance with the reciprocity factor having a value that is greater than or equal to the first threshold but less than or equal to the second threshold.

As indicated above, FIG. 6 is provided as an example. Other examples may differ from what is described with regard to FIG. 6.

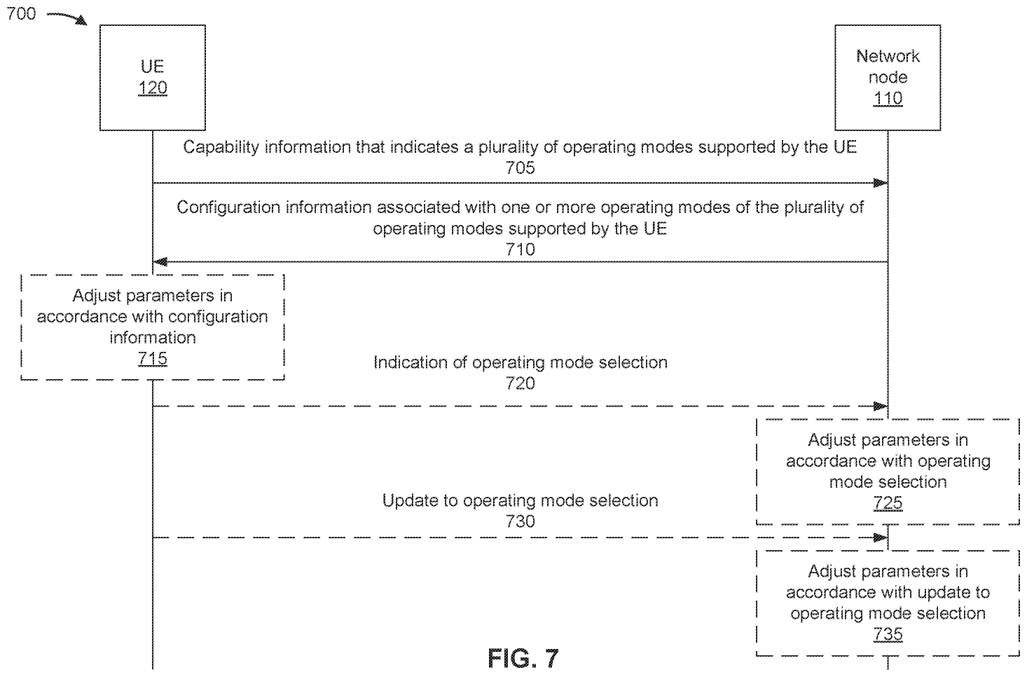

FIG. 7 is a diagram illustrating an example 700 of UE and network node coordination, in accordance with the present disclosure.

As shown by reference number 705, the UE 120 may transmit, and the network node 110 may receive, capability information that indicates a plurality of operating modes (e.g., smart modes) supported by the UE 120. In some aspects, the operating modes may be based at least in part on a mobility parameter, a radio frequency parameter, a location parameter, and/or a sensor parameter. Additionally, or alternatively, the operating modes may be based at least in part on whether the UE 120 is in a subway, on a high-speed train, at a home location, at an office location, at an indoor location, at an outdoor location, in an elevator, in a high-network load scenario, in a light-network load scenario, in a high-interference scenario, in a low-interference scenario, or whether a particular application is operating on the UE 120. In one example, transmitting the capability information may include transmitting capability information indicating that the UE 120 supports smart modes A, B, C, D, E, and F.

As shown by reference number 710, the network node 110 may transmit, and the UE 120 may receive, configuration information associated with one or more operating modes of the plurality of operating modes. For example, the network node 110 may transmit information indicating that the network node 110 supports one or more operating modes of the plurality of operating modes supported by the UE 120. In one example, transmitting the configuration information may include transmitting configuration information indicating that the network node supports smart modes A and B, but does not support smart modes C, D, E, or F. In some aspects, transmitting the configuration information may include transmitting configuration information for the one or more smart modes supported by the UE 120 and the network node 110, and/or transmitting an indication for the UE 120 to enable the one or more smart modes supported by the UE 120 and the network node 110.

As shown by reference number 715, the UE 120 may adjust one or more parameters in accordance with the configuration information. For example, the UE 120 may adjust a mobility parameter, a radio frequency parameter, a location parameter, a sensor parameter, and/or may adjust (e.g., open or close) one or more applications operating on the UE 120.

As shown by reference number 720, the UE 120 may transmit, and the network node 110 may receive, an indication of an operating mode selection. For example, the UE 120 may transmit an indication of a selection of smart mode A (e.g., a smart mode associated with being located on a high-speed train). In some aspects, the indication of the operating mode selection may be an indication of an operating mode activation. For example, the indication of the operating mode selection may be an indication that the UE 120 has activated a smart mode. In some aspects, the indication of the operating mode selection may be an indication of a selection of a plurality of operating modes. For example, the indication of the operating mode selection may be an indication of a selection of smart mode A and smart mode B (e.g., a smart mode associated with operating a first application on the UE 120).

As shown by reference number 725, the network node 110 may adjust one or more parameters in accordance with the indication of the operating mode selection. In some aspects, the network node 110 may adjust a scheduling parameter, a feature setting parameter, a layer management parameter, and/or a load balancing parameter, among other examples, that are configured (e.g., optimized) for an enabled smart mode. For example, in accordance with receiving the indication that the UE 120 has enabled smart mode A, the network node 110 may adjust a scheduling parameter, a feature setting parameter, a layer management parameter, and/or a load balancing parameter that is optimized for smart mode A.

As shown by reference number 730, the UE 120 may transmit, and the network node 110 may receive, an indication of an updated operating mode selection. For example, the UE 120 may transmit, and the network node 110 may receive, an indication that the UE 120 has switched from smart mode A to smart mode B. Alternatively, the UE 120 may transmit, and the network node 110 may receive, an indication that the UE 120 has switched from smart mode A to smart mode C.

As shown by reference number 735, the network node 110 may adjust one or more parameters in accordance with the indication of the updated operating mode selection. In the example where the UE 120 has switched from smart mode A to smart mode B (which is supported by the network node 110), the network node 110 may adjust one or more parameters that are optimized for smart mode B. Alternatively, in the example where the UE 120 has switched from smart mode A to smart mode C (which is not supported by the network node 110), the network node 110 may refrain from adjusting parameters, or may switch to one or more default parameters.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with UE and network node coordination.

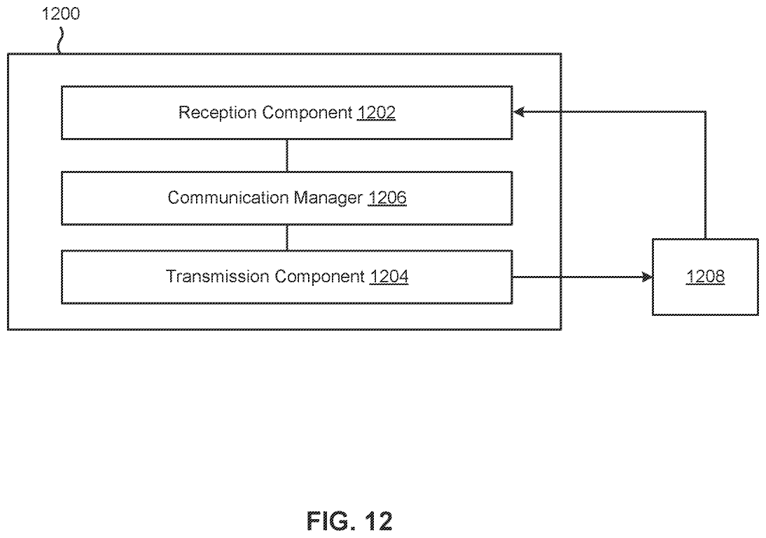

As shown in FIG. 8, in some aspects, process 800 may include transmitting capability information associated with performing reciprocity-based communications, the reciprocity-based communications being in accordance with one or more sounding reference signals associated with one or more ports (block 810). For example, the UE (e.g., using transmission component 1204 and/or communication manager 1206, depicted in FIG. 12) may transmit capability information associated with performing reciprocity-based communications, the reciprocity-based communications being in accordance with one or more sounding reference signals associated with one or more ports, as described above.

As further shown in FIG. 8, in some aspects, process 800 may include receiving, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements (block 820). For example, the UE (e.g., using reception component 1202 and/or communication manager 1206, depicted in FIG. 12) may receive, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements, as described above.

Process 800 may include additional aspects, such as any single aspect or any combination of aspects described below and/or in connection with one or more other processes described elsewhere herein.

In a first aspect, process 800 includes transmitting a channel state information measurement in accordance with receiving the indication to perform reciprocity-based communications, wherein transmitting the channel state information measurement comprises transmitting at least one of a channel quality indicator, a precoding matrix indicator, a rank indicator, or a reciprocity factor associated with an uplink channel and a downlink channel.

In a second aspect, alone or in combination with the first aspect, process 800 includes reducing a frequency of channel state information measurement or channel state information transmissions by the UE in accordance with receiving the indication to perform reciprocity-based communications.

In a third aspect, alone or in combination with one or more of the first and second aspects, process 800 includes reducing a frequency of sounding reference signal transmissions by the UE in accordance with receiving the indication to perform codebook-based communications.

In a fourth aspect, alone or in combination with one or more of the first through third aspects, receiving the indication to perform reciprocity-based communications, the indication to perform codebook-based communications, or the indication to perform the combination of reciprocity-based communications and codebook-based communications comprises receiving a plurality of bits, wherein a first value of the plurality of bits indicates to perform reciprocity-based communications, a second value of the plurality of bits indicates to perform codebook-based communications, and a third value of the plurality of bits indicates to perform the combination of reciprocity-based communications and codebook-based communications.

In a fifth aspect, alone or in combination with one or more of the first through fourth aspects, the indication to perform reciprocity-based communications is an indication to switch to performing reciprocity-based communications at a select slot of a plurality of slots, or the indication to perform codebook-based communications is an indication to switch to performing codebook-based communications at the select slot of the plurality of slots.

In a sixth aspect, alone or in combination with one or more of the first through fifth aspects, process 800 includes performing one or more channel reciprocity measurements, wherein transmitting the capability information comprises transmitting the capability information in accordance with the one or more channel reciprocity measurements.

In a seventh aspect, alone or in combination with one or more of the first through sixth aspects, the one or more channel reciprocity measurements include at least one of a distance measurement, a path-loss measurement, or a transmission timing difference.

In an eighth aspect, alone or in combination with one or more of the first through seventh aspects, process 800 includes transmitting a reciprocity indicator that indicates a similarity between an uplink channel and a downlink channel.

In a ninth aspect, alone or in combination with one or more of the first through eighth aspects, transmitting the reciprocity indicator comprises periodically transmitting the reciprocity indicator in accordance with an interval.

In a tenth aspect, alone or in combination with one or more of the first through ninth aspects, transmitting the reciprocity indicator comprises aperiodically transmitting the reciprocity indicator in accordance with an occurrence of an event.

In an eleventh aspect, alone or in combination with one or more of the first through tenth aspects, transmitting the reciprocity indicator comprises transmitting at least one of a radio resource control message, a medium access control message, or channel state information that includes an indication of the reciprocity indicator.

In a twelfth aspect, alone or in combination with one or more of the first through eleventh aspects, process 800 includes performing codebook-based communications in accordance with the reciprocity indicator having a value that is less than a first threshold, performing reciprocity-based communications in accordance with the reciprocity indicator having a value that is greater than a second threshold, or performing the combination of reciprocity-based communications and codebook-based communications in accordance with the reciprocity indicator having a value that is greater than or equal to the first threshold and less than or equal to the second threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with UE and network node coordination.

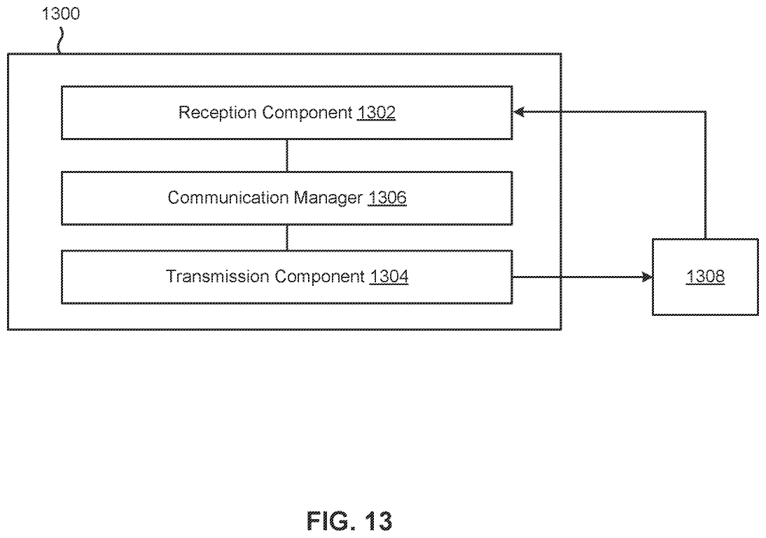

As shown in FIG. 9, in some aspects, process 900 may include receiving capability information associated with a UE performing reciprocity-based communications, the reciprocity-based communications being in accordance with one or more sounding reference signals associated with one or more ports (block 910). For example, the network node (e.g., using reception component 1302 and/or communication manager 1306, depicted in FIG. 13) may receive capability information associated with a UE performing reciprocity-based communications, the reciprocity-based communications being in accordance with one or more sounding reference signals associated with one or more ports, as described above.

As further shown in FIG. 9, in some aspects, process 900 may include transmitting, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements (block 920). For example, the network node (e.g., using transmission component 1304 and/or communication manager 1306, depicted in FIG. 13) may transmit, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements, as described above.

Process 900 may include additional aspects, such as any single aspect or any combination of aspects described below and/or in connection with one or more other processes described elsewhere herein.

In a first aspect, process 900 includes generating the indication to perform reciprocity-based communications, the indication to perform codebook-based communications, or the indication to perform the combination of reciprocity-based communications and codebook-based communications in accordance with the capability information.

In a second aspect, alone or in combination with the first aspect, process 900 includes generating the indication to perform reciprocity-based communications, or indication to perform codebook-based communications, or the indication to perform the combination of reciprocity-based communications and codebook-based communications without using the capability information.

In a third aspect, alone or in combination with one or more of the first and second aspects, process 900 includes receiving a channel state information measurement in accordance with transmitting the indication to perform reciprocity-based communications, wherein receiving the channel state information measurement comprises receiving at least one of a channel quality indicator, a precoding matrix indicator, a rank indicator, or a reciprocity factor associated with an uplink channel and a downlink channel.

In a fourth aspect, alone or in combination with one or more of the first through third aspects, process 900 includes receiving one or more sounding reference signals in accordance with transmitting the indication to perform codebook-based communications.

In a fifth aspect, alone or in combination with one or more of the first through fourth aspects, transmitting the indication to perform reciprocity-based communications, the indication to perform codebook-based communications, or the indication to perform the combination of reciprocity-based communications and codebook-based communications comprises transmitting a plurality of bits, wherein a first value of the plurality of bits indicates to perform reciprocity-based communications, a second value of the plurality of bits indicates to perform codebook-based communications, and a third value of the plurality of bits indicates to perform the combination of reciprocity-based communications and codebook-based communications.

In a sixth aspect, alone or in combination with one or more of the first through fifth aspects, the indication to perform reciprocity-based communications is an indication to switch to performing reciprocity-based communications at a select slot of a plurality of slots, or the indication to perform codebook-based communications is an indication to switch to performing codebook-based communications at the select slot of the plurality of slots.

In a seventh aspect, alone or in combination with one or more of the first through sixth aspects, receiving the capability information comprises receiving the capability information in accordance with one or more channel reciprocity measurements.

In an eighth aspect, alone or in combination with one or more of the first through seventh aspects, the one or more channel reciprocity measurements include at least one of a distance measurement, a path-loss measurement, or a transmission timing difference.

In a ninth aspect, alone or in combination with one or more of the first through eighth aspects, process 900 includes receiving a reciprocity indicator that indicates a similarity between an uplink channel and a downlink channel.

In a tenth aspect, alone or in combination with one or more of the first through ninth aspects, receiving the reciprocity indicator comprises periodically receiving the reciprocity indicator in accordance with an interval.

In an eleventh aspect, alone or in combination with one or more of the first through tenth aspects, receiving the reciprocity indicator comprises aperiodically receiving the reciprocity indicator in accordance with an occurrence of an event.

In a twelfth aspect, alone or in combination with one or more of the first through eleventh aspects, receiving the reciprocity indicator comprises receiving at least one of a radio resource control message, a medium access control message, or channel state information that includes an indication of the reciprocity indicator.

In a thirteenth aspect, alone or in combination with one or more of the first through twelfth aspects, process 900 includes identifying whether to communicate with the UE using reciprocity-based communications or codebook-based communications in accordance with the reciprocity indicator and a plurality of thresholds.

In a fourteenth aspect, alone or in combination with one or more of the first through thirteenth aspects, transmitting the indication to perform reciprocity-based communications or the indication to perform codebook-based communications comprises transmitting the indication to perform codebook-based communications in accordance with the reciprocity indicator having a value that is less than a first threshold of the plurality of thresholds, transmitting the indication to perform reciprocity-based communications in accordance with the reciprocity indicator having a value that is greater than a second threshold of the plurality of thresholds, or transmitting an indication to perform the combination of reciprocity-based communications and codebook-based communications in accordance with the reciprocity indicator having a value that is greater than or equal to the first threshold and less than or equal to the second threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with UE and network node coordination.

As shown in FIG. 10, in some aspects, process 1000 may include transmitting capability information that indicates a plurality of operating modes supported by the UE, the plurality of operating modes being in accordance with at least one of a location of the UE, a network performance indicator, a power savings indicator, or one or more applications associated with the UE (block 1010). For example, the UE (e.g., using transmission component 1204 and/or communication manager 1206, depicted in FIG. 12) may transmit capability information that indicates a plurality of operating modes supported by the UE, the plurality of operating modes being in accordance with at least one of a location of the UE, a network performance indicator, a power savings indicator, or one or more applications associated with the UE, as described above.

As further shown in FIG. 10, in some aspects, process 1000 may include receiving, in accordance with transmitting the capability information, configuration information associated with one or more operating modes of the plurality of operating modes supported by the UE (block 1020). For example, the UE (e.g., using reception component 1202 and/or communication manager 1206, depicted in FIG. 12) may receive, in accordance with transmitting the capability information, configuration information associated with one or more operating modes of the plurality of operating modes supported by the UE, as described above.

Process 1000 may include additional aspects, such as any single aspect or any combination of aspects described below and/or in connection with one or more other processes described elsewhere herein.

In a first aspect, the configuration information indicates for the UE to enable the one or more operating modes of the plurality of operating modes supported by the UE.

In a second aspect, alone or in combination with the first aspect, process 1000 includes adjusting, in accordance with receiving the configuration information, at least one of an application associated with the UE, a mobility parameter, a radio frequency parameter, a location parameter, or a sensor parameter.

In a third aspect, alone or in combination with one or more of the first and second aspects, process 1000 includes transmitting an indication that the UE has activated an operating mode of the one or more operating modes.

In a fourth aspect, alone or in combination with one or more of the first through third aspects, transmitting the indication that the UE has activated the operating mode comprises transmitting at least one of a radio resource control message, a medium access control message, or channel state information that includes the indication that the UE has activated the operating mode.

In a fifth aspect, alone or in combination with one or more of the first through fourth aspects, process 1000 includes receiving a grant indication, a handover indication, or a redirection indication in accordance with transmitting the indication that the UE has activated the operating mode.

In a sixth aspect, alone or in combination with one or more of the first through fifth aspects, process 1000 includes transmitting an indication that the UE has activated another operating mode of the one or more operating modes, and receiving an updated grant indication, an updated handover indication, or an updated redirection indication in accordance with transmitting the indication that the UE has activated the other operating mode.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with UE and network node coordination.

As shown in FIG. 11, in some aspects, process 1100 may include receiving capability information that indicates a plurality of operating modes supported by a UE, the plurality of operating modes being in accordance with at least one of a location of the UE, a network performance indicator, a power savings indicator, or one or more applications associated with the UE (block 1110). For example, the network node (e.g., using reception component 1302 and/or communication manager 1306, depicted in FIG. 13) may receive capability information that indicates a plurality of operating modes supported by a UE, the plurality of operating modes being in accordance with at least one of a location of the UE, a network performance indicator, a power savings indicator, or one or more applications associated with the UE, as described above.

As further shown in FIG. 11, in some aspects, process 1100 may include transmitting, in accordance with receiving the capability information, configuration information associated with one or more operating modes of the plurality of operating modes supported by the UE (block 1120). For example, the network node (e.g., using transmission component 1304 and/or communication manager 1306, depicted in FIG. 13) may transmit, in accordance with receiving the capability information, configuration information associated with one or more operating modes of the plurality of operating modes supported by the UE, as described above.

Process 1100 may include additional aspects, such as any single aspect or any combination of aspects described below and/or in connection with one or more other processes described elsewhere herein.

In a first aspect, the configuration information indicates for the UE to enable the one or more operating modes of the plurality of operating modes supported by the UE.

In a second aspect, alone or in combination with the first aspect, process 1100 includes identifying the one or more operating modes of the plurality of operating modes based at least in part on network node capability information.

In a third aspect, alone or in combination with one or more of the first and second aspects, process 1100 includes receiving an indication that the UE has activated an operating mode of the one or more operating modes.

In a fourth aspect, alone or in combination with one or more of the first through third aspects, receiving the indication that the UE has activated the operating mode comprises receiving at least one of a radio resource control message, a medium access control message, or channel state information that includes the indication that the UE has activated the operating mode.

In a fifth aspect, alone or in combination with one or more of the first through fourth aspects, process 1100 includes adjusting at least one of scheduling information, layer management information, or load balancing information in accordance with receiving the indication that the UE has activated the operating mode.

In a sixth aspect, alone or in combination with one or more of the first through fifth aspects, process 1100 includes transmitting a grant indication, a handover indication, or a redirection indication in accordance with receiving the indication that the UE has activated the operating mode.

In a seventh aspect, alone or in combination with one or more of the first through sixth aspects, process 1100 includes receiving an indication that the UE has activated another operating mode of the one or more operating modes, and transmitting an updated grant indication, an updated handover indication, or an updated redirection indication in accordance with receiving the indication that the UE has activated the other operating mode.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit capability information associated with performing reciprocity-based communications, the reciprocity-based communications being in accordance with one or more sounding reference signals associated with one or more ports. The reception component 1202 may receive, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

The transmission component 1204 may transmit a channel state information measurement in accordance with receiving the indication to perform reciprocity-based communications, wherein transmitting the channel state information measurement comprises transmitting at least one of a channel quality indicator, a precoding matrix indicator, a rank indicator, or a reciprocity factor associated with an uplink channel and a downlink channel.

The communication manager 1206 may reduce a frequency of channel state information measurement or channel state information transmissions by the UE in accordance with receiving the indication to perform reciprocity-based communications. The communication manager 1206 may reduce a frequency of sounding reference signal transmissions by the UE in accordance with receiving the indication to perform codebook-based communications. The communication manager 1206 may perform one or more channel reciprocity measurements, wherein transmitting the capability information comprises transmitting the capability information in accordance with the one or more channel reciprocity measurements. The transmission component 1204 may transmit a reciprocity indicator that indicates a similarity between an uplink channel and a downlink channel.

The transmission component 1204 may transmit capability information that indicates a plurality of operating modes supported by the UE, the plurality of operating modes being in accordance with at least one of a location of the UE, a network performance indicator, a power savings indicator, or one or more applications associated with the UE. The reception component 1202 may receive, in accordance with transmitting the capability information, configuration information associated with one or more operating modes of the plurality of operating modes supported by the UE.

The communication manager 1206 may adjust, in accordance with receiving the configuration information, at least one of an application associated with the UE, a mobility parameter, a radio frequency parameter, a location parameter, or a sensor parameter. The transmission component 1204 may transmit an indication that the UE has activated an operating mode of the one or more operating modes. The reception component 1202 may receive a grant indication, a handover indication, or a redirection indication in accordance with transmitting the indication that the UE has activated the operating mode. The transmission component 1204 may transmit an indication that the UE has activated another operating mode of the one or more operating modes. The reception component 1202 may receive an updated grant indication, an updated handover indication, or an updated redirection indication in accordance with transmitting the indication that the UE has activated the other operating mode.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive capability information associated with a UE performing reciprocity-based communications, the reciprocity-based communications being in accordance with one or more sounding reference signals associated with one or more ports. The transmission component 1304 may transmit, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

The communication manager 1306 may generate the indication to perform reciprocity-based communications, the indication to perform codebook-based communications, or the indication to perform the combination of reciprocity-based communications and codebook-based communications in accordance with the capability information. The communication manager 1306 may generate the indication to perform reciprocity-based communications, or indication to perform codebook-based communications, or the indication to perform the combination of reciprocity-based communications and codebook-based communications without using the capability information. The reception component 1302 may receive a channel state information measurement in accordance with transmitting the indication to perform reciprocity-based communications, wherein receiving the channel state information measurement comprises receiving at least one of a channel quality indicator, a precoding matrix indicator, a rank indicator, or a reciprocity factor associated with an uplink channel and a downlink channel. The reception component 1302 may receive one or more sounding reference signals in accordance with transmitting the indication to perform codebook-based communications. The reception component 1302 may receive a reciprocity indicator that indicates a similarity between an uplink channel and a downlink channel. The communication manager 1306 may identify whether to communicate with the UE using reciprocity-based communications or codebook-based communications in accordance with the reciprocity indicator and a plurality of thresholds.

The reception component 1302 may receive capability information that indicates a plurality of operating modes supported by a UE, the plurality of operating modes being in accordance with at least one of a location of the UE, a network performance indicator, a power savings indicator, or one or more applications associated with the UE. The transmission component 1304 may transmit, in accordance with receiving the capability information, configuration information associated with one or more operating modes of the plurality of operating modes supported by the UE.

The communication manager 1306 may identify the one or more operating modes of the plurality of operating modes based at least in part on network node capability information. The reception component 1302 may receive an indication that the UE has activated an operating mode of the one or more operating modes. The communication manager 1306 may adjust at least one of scheduling information, layer management information, or load balancing information in accordance with receiving the indication that the UE has activated the operating mode. The transmission component 1304 may transmit a grant indication, a handover indication, or a redirection indication in accordance with receiving the indication that the UE has activated the operating mode. The reception component 1302 may receive an indication that the UE has activated another operating mode of the one or more operating modes. The transmission component 1304 may transmit an updated grant indication, an updated handover indication, or an updated redirection indication in accordance with receiving the indication that the UE has activated the other operating mode.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting capability information associated with performing reciprocity-based communications, the reciprocity-based communications being in accordance with one or more sounding reference signals associated with one or more ports; and receiving, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

Aspect 2: The method of Aspect 1, further comprising transmitting a channel state information measurement in accordance with receiving the indication to perform reciprocity-based communications, wherein transmitting the channel state information measurement comprises transmitting at least one of a channel quality indicator, a precoding matrix indicator, a rank indicator, or a reciprocity factor associated with an uplink channel and a downlink channel.

Aspect 3: The method of Aspect 2, further comprising reducing a frequency of channel state information measurement or channel state information transmissions by the UE in accordance with receiving the indication to perform reciprocity-based communications.

Aspect 4: The method of any of Aspects 1-3, further comprising reducing a frequency of sounding reference signal transmissions by the UE in accordance with receiving the indication to perform codebook-based communications.

Aspect 5: The method of any of Aspects 1-4, wherein receiving the indication to perform reciprocity-based communications, the indication to perform codebook-based communications, or the indication to perform the combination of reciprocity-based communications and codebook-based communications comprises receiving a plurality of bits, wherein a first value of the plurality of bits indicates to perform reciprocity-based communications, a second value of the plurality of bits indicates to perform codebook-based communications, and a third value of the plurality of bits indicates to perform the combination of reciprocity-based communications and codebook-based communications.

Aspect 6: The method of any of Aspects 1-5, wherein the indication to perform reciprocity-based communications is an indication to switch to performing reciprocity-based communications at a select slot of a plurality of slots, or wherein the indication to perform codebook-based communications is an indication to switch to performing codebook-based communications at the select slot of the plurality of slots.

Aspect 7: The method of any of Aspects 1-6, further comprising performing one or more channel reciprocity measurements, wherein transmitting the capability information comprises transmitting the capability information in accordance with the one or more channel reciprocity measurements.

Aspect 8: The method of Aspect 7, wherein the one or more channel reciprocity measurements include at least one of a distance measurement, a path-loss measurement, or a transmission timing difference.

Aspect 9: The method of any of Aspects 1-8, further comprising transmitting a reciprocity indicator that indicates a similarity between an uplink channel and a downlink channel.

Aspect 10: The method of Aspect 9, wherein transmitting the reciprocity indicator comprises periodically transmitting the reciprocity indicator in accordance with an interval.

Aspect 11: The method of Aspect 9, wherein transmitting the reciprocity indicator comprises aperiodically transmitting the reciprocity indicator in accordance with an occurrence of an event.

Aspect 12: The method of Aspect 9, wherein transmitting the reciprocity indicator comprises transmitting at least one of a radio resource control message, a medium access control (MAC) control element, or channel state information that includes an indication of the reciprocity indicator.

Aspect 13: The method of Aspect 9, wherein the UE is configured to perform codebook-based communications in accordance with the reciprocity indicator having a value that is less than a first threshold, perform reciprocity-based communications in accordance with the reciprocity indicator having a value that is greater than a second threshold, or perform the combination of reciprocity-based communications and codebook-based communications in accordance with the reciprocity indicator having a value that is greater than or equal to the first threshold and less than or equal to the second threshold.

Aspect 14: A method of wireless communication performed by a network node, comprising: receiving capability information associated with a user equipment (UE) performing reciprocity-based communications, the reciprocity-based communications being in accordance with one or more sounding reference signals associated with one or more ports; and transmitting, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

Aspect 15: The method of Aspect 14, further comprising generating the indication to perform reciprocity-based communications, the indication to perform codebook-based communications, or the indication to perform the combination of reciprocity-based communications and codebook-based communications in accordance with the capability information.

Aspect 16: The method of any of Aspects 14-15, further comprising generating the indication to perform reciprocity-based communications, or indication to perform codebook-based communications, or the indication to perform the combination of reciprocity-based communications and codebook-based communications without using the capability information.

Aspect 17: The method of any of Aspects 14-16, further comprising receiving a channel state information measurement in accordance with transmitting the indication to perform reciprocity-based communications, wherein receiving the channel state information measurement comprises receiving at least one of a channel quality indicator, a precoding matrix indicator, a rank indicator, or a reciprocity factor associated with an uplink channel and a downlink channel.

Aspect 18: The method of any of Aspects 14-17, further comprising receiving one or more sounding reference signals in accordance with transmitting the indication to perform codebook-based communications.

Aspect 19: The method of any of Aspects 14-18, wherein transmitting the indication to perform reciprocity-based communications, the indication to perform codebook-based communications, or the indication to perform the combination of reciprocity-based communications and codebook-based communications comprises transmitting a plurality of bits, wherein a first value of the plurality of bits indicates to perform reciprocity-based communications, a second value of the plurality of bits indicates to perform codebook-based communications, and a third value of the plurality of bits indicates to perform the combination of reciprocity-based communications and codebook-based communications.

Aspect 20: The method of any of Aspects 14-19, wherein the indication to perform reciprocity-based communications is an indication to switch to performing reciprocity-based communications at a select slot of a plurality of slots, or wherein the indication to perform codebook-based communications is an indication to switch to performing codebook-based communications at the select slot of the plurality of slots.

Aspect 21: The method of any of Aspects 14-20, wherein receiving the capability information comprises receiving the capability information in accordance with one or more channel reciprocity measurements.

Aspect 22: The method of Aspect 21, wherein the one or more channel reciprocity measurements include at least one of a distance measurement, a path-loss measurement, or a transmission timing difference.

Aspect 23: The method of any of Aspects 14-22, further comprising receiving a reciprocity indicator that indicates a similarity between an uplink channel and a downlink channel.

Aspect 24: The method of Aspect 23, wherein receiving the reciprocity indicator comprises periodically receiving the reciprocity indicator in accordance with an interval.

Aspect 25: The method of Aspect 23, wherein receiving the reciprocity indicator comprises aperiodically receiving the reciprocity indicator in accordance with an occurrence of an event.

Aspect 26: The method of Aspect 23, wherein receiving the reciprocity indicator comprises receiving at least one of a radio resource control message, a medium access control (MAC) control element, or channel state information that includes an indication of the reciprocity indicator.

Aspect 27: The method of Aspect 23, further comprising identifying whether to communicate with the UE using reciprocity-based communications or codebook-based communications in accordance with the reciprocity indicator and a plurality of thresholds.

Aspect 28: The method of Aspect 27, wherein transmitting the indication to perform reciprocity-based communications or the indication to perform codebook-based communications comprises: transmitting the indication to perform codebook-based communications in accordance with the reciprocity indicator having a value that is less than a first threshold of the plurality of thresholds; transmitting the indication to perform reciprocity-based communications in accordance with the reciprocity indicator having a value that is greater than a second threshold of the plurality of thresholds; or transmitting an indication to perform the combination of reciprocity-based communications and codebook-based communications in accordance with the reciprocity indicator having a value that is greater than or equal to the first threshold and less than or equal to the second threshold.

Aspect 29: A method of wireless communication performed by a user equipment (UE), comprising: transmitting capability information that indicates a plurality of operating modes supported by the UE, the plurality of operating modes being in accordance with at least one of a location of the UE, a network performance indicator, a power savings indicator, or one or more applications associated with the UE; and receiving, in accordance with transmitting the capability information, configuration information associated with one or more operating modes of the plurality of operating modes supported by the UE.

Aspect 30: The method of Aspect 29, wherein the configuration information indicates for the UE to enable the one or more operating modes of the plurality of operating modes supported by the UE.

Aspect 31: The method of any of Aspects 29-30, further comprising adjusting, in accordance with receiving the configuration information, at least one of an application associated with the UE, a mobility parameter, a radio frequency parameter, a location parameter, or a sensor parameter.

Aspect 32: The method of any of Aspects 29-31, further comprising transmitting an indication that the UE has activated an operating mode of the one or more operating modes.

Aspect 33: The method of Aspect 32, wherein transmitting the indication that the UE has activated the operating mode comprises transmitting at least one of a radio resource control message, a medium access control (MAC) control element, or channel state information that includes the indication that the UE has activated the operating mode.

Aspect 34: The method of Aspect 32, further comprising receiving a grant indication, a handover indication, or a redirection indication in accordance with transmitting the indication that the UE has activated the operating mode.

Aspect 35: The method of Aspect 34, further comprising: transmitting an indication that the UE has activated another operating mode of the one or more operating modes; and receiving an updated grant indication, an updated handover indication, or an updated redirection indication in accordance with transmitting the indication that the UE has activated the other operating mode.

Aspect 36: A method of wireless communication performed by a network node, comprising: receiving capability information that indicates a plurality of operating modes supported by a user equipment (UE), the plurality of operating modes being in accordance with at least one of a location of the UE, a network performance indicator, a power savings indicator, or one or more applications associated with the UE; and transmitting, in accordance with receiving the capability information, configuration information associated with one or more operating modes of the plurality of operating modes supported by the UE.

Aspect 37: The method of Aspect 36, wherein the configuration information indicates for the UE to enable the one or more operating modes of the plurality of operating modes supported by the UE.

Aspect 38: The method of any of Aspects 36-37, further comprising identifying the one or more operating modes of the plurality of operating modes based at least in part on network node capability information.

Aspect 39: The method of any of Aspects 36-38, further comprising receiving an indication that the UE has activated an operating mode of the one or more operating modes.

Aspect 40: The method of Aspect 39, wherein receiving the indication that the UE has activated the operating mode comprises receiving at least one of a radio resource control message, a medium access control (MAC) control element, or channel state information that includes the indication that the UE has activated the operating mode.

Aspect 41: The method of Aspect 39, further comprising adjusting at least one of scheduling information, layer management information, or load balancing information in accordance with receiving the indication that the UE has activated the operating mode.

Aspect 42: The method of Aspect 39, further comprising transmitting a grant indication, a handover indication, or a redirection indication in accordance with receiving the indication that the UE has activated the operating mode.

Aspect 43: The method of Aspect 42, further comprising: receiving an indication that the UE has activated another operating mode of the one or more operating modes; and transmitting an updated grant indication, an updated handover indication, or an updated redirection indication in accordance with receiving the indication that the UE has activated the other operating mode.

Aspect 44: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-43.

Aspect 45: An apparatus for wireless communication at a device, the apparatus comprising one or more memories and one or more processors coupled to the one or more memories, the one or more processors configured to cause the device to perform the method of one or more of Aspects 1-43.

Aspect 46: An apparatus for wireless communication, the apparatus comprising at least one means for performing the method of one or more of Aspects 1-43.

Aspect 47: A non-transitory computer-readable medium storing code for wireless communication, the code comprising instructions executable by one or more processors to perform the method of one or more of Aspects 1-43.

Aspect 48: A non-transitory computer-readable medium storing a set of instructions for wireless communication, the set of instructions comprising one or more instructions that, when executed by one or more processors of a device, cause the device to perform the method of one or more of Aspects 1-43.

Aspect 49: A device for wireless communication, the device comprising a processing system that includes one or more processors and one or more memories coupled with the one or more processors, the processing system configured to cause the device to perform the method of one or more of Aspects 1-43.

Aspect 50: An apparatus for wireless communication at a device, the apparatus comprising one or more memories and one or more processors coupled to the one or more memories, the one or more processors individually or collectively configured to cause the device to perform the method of one or more of Aspects 1-43.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, which are configured, individually or in any combination, to cause the UE to:
transmit capability information associated with performing reciprocity-based communications, the reciprocity-based communications being in accordance with one or more sounding reference signals associated with one or more ports; and
receive, in accordance with transmitting the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

2. The apparatus of claim 1, wherein the one or more processors are further configured to cause the UE to transmit a channel state information measurement in accordance with receiving the indication to perform reciprocity-based communications, wherein transmitting the channel state information measurement comprises transmitting at least one of a channel quality indicator, a precoding matrix indicator, a rank indicator, or a reciprocity factor associated with an uplink channel and a downlink channel.

3. The apparatus of claim 2, wherein the one or more processors are further configured to cause the UE to reduce a frequency of channel state information measurement or channel state information transmissions by the UE in accordance with receiving the indication to perform reciprocity-based communications.

4. The apparatus of claim 1, wherein the one or more processors are further configured to cause the UE to reduce a frequency of sounding reference signal transmissions by the UE in accordance with receiving the indication to perform codebook-based communications.

5. The apparatus of claim 1, wherein receiving the indication to perform reciprocity-based communications, the indication to perform codebook-based communications, or the indication to perform the combination of reciprocity-based communications and codebook-based communications comprises receiving a plurality of bits, wherein a first value of the plurality of bits indicates to perform reciprocity-based communications, a second value of the plurality of bits indicates to perform codebook-based communications, and a third value of the plurality of bits indicates to perform the combination of reciprocity-based communications and codebook-based communications.

6. The apparatus of claim 1, wherein the indication to perform reciprocity-based communications is an indication to switch to performing reciprocity-based communications at a select slot of a plurality of slots, or wherein the indication to perform codebook-based communications is an indication to switch to performing codebook-based communications at the select slot of the plurality of slots.

7. The apparatus of claim 1, wherein the one or more processors are further configured to cause the UE to perform one or more channel reciprocity measurements, wherein transmitting the capability information comprises transmitting the capability information in accordance with the one or more channel reciprocity measurements, wherein the one or more channel reciprocity measurements include at least one of a distance measurement, a path-loss measurement, or a transmission timing difference.

8. The apparatus of claim 1, wherein the one or more processors are further configured to cause the UE to transmit a reciprocity indicator that indicates a similarity between an uplink channel and a downlink channel.

9. The apparatus of claim 8, wherein the one or more processors, to cause the UE to transmit the reciprocity indicator, are configured to cause the UE to periodically transmit the reciprocity indicator in accordance with an interval.

10. The apparatus of claim 8, wherein the one or more processors, to cause the UE to transmit the reciprocity indicator, are configured to cause the UE to aperiodically transmit the reciprocity indicator in accordance with an occurrence of an event.

11. The apparatus of claim 8, wherein the one or more processors are further configured to cause the UE to perform codebook-based communications in accordance with the reciprocity indicator having a value that is less than a first threshold, perform reciprocity-based communications in accordance with the reciprocity indicator having a value that is greater than a second threshold, or perform the combination of reciprocity-based communications and codebook-based communications in accordance with the reciprocity indicator having a value that is greater than or equal to the first threshold and less than or equal to the second threshold.

12. An apparatus for wireless communication at a network node, comprising:
one or more memories; and
one or more processors, coupled to the one or more memories, which are configured, individually or in any combination, to cause the network node to:
receive capability information associated with a user equipment (UE) performing reciprocity-based communications, the reciprocity-based communications being in accordance with one or more sounding reference signals associated with one or more ports; and
transmit, in accordance with receiving the capability information, at least one of an indication to perform reciprocity-based communications, an indication to perform codebook-based communications, or an indication to perform a combination of reciprocity-based communications and codebook-based communications, the codebook-based communications being in accordance with one or more channel state information measurements.

13. The apparatus of claim 12, wherein the one or more processors are further configured to cause the network node to generate the indication to perform reciprocity-based communications, the indication to perform codebook-based communications, or the indication to perform the combination of reciprocity-based communications and codebook-based communications in accordance with the capability information.

14. The apparatus of claim 12, wherein the one or more processors are further configured to cause the network node to generate the indication to perform reciprocity-based communications, or indication to perform codebook-based communications, or the indication to perform the combination of reciprocity-based communications and codebook-based communications without using the capability information.

15. The apparatus of claim 12, wherein the one or more processors are further configured to cause the network node to receive a channel state information measurement in accordance with transmitting the indication to perform reciprocity-based communications, wherein receiving the channel state information measurement comprises receiving at least one of a channel quality indicator, a precoding matrix indicator, a rank indicator, or a reciprocity factor associated with an uplink channel and a downlink channel.

16. The apparatus of claim 12, wherein the one or more processors are further configured to cause the network node to receive one or more sounding reference signals in accordance with transmitting the indication to perform codebook-based communications.

17. The apparatus of claim 12, wherein transmitting the indication to perform reciprocity-based communications, the indication to perform codebook-based communications, or the indication to perform the combination of reciprocity-based communications and codebook-based communications comprises transmitting a plurality of bits, wherein a first value of the plurality of bits indicates to perform reciprocity-based communications, a second value of the plurality of bits indicates to perform codebook-based communications, and a third value of the plurality of bits indicates to perform the combination of reciprocity-based communications and codebook-based communications.

18. The apparatus of claim 12, wherein the indication to perform reciprocity-based communications is an indication to switch to performing reciprocity-based communications at a select slot of a plurality of slots, or wherein the indication to perform codebook-based communications is an indication to switch to performing codebook-based communications at the select slot of the plurality of slots.

19. The apparatus of claim 12, wherein the one or more processors, to cause the network node to receive the capability information, are configured to cause the network node to receive the capability information in accordance with one or more channel reciprocity measurements, wherein the one or more channel reciprocity measurements include at least one of a distance measurement, a path-loss measurement, or a transmission timing difference.

20. The apparatus of claim 12, wherein the one or more processors are further configured to cause the network node to receive a reciprocity indicator that indicates a similarity between an uplink channel and a downlink channel.

21. The apparatus of claim 20, wherein the one or more processors are further configured to cause the network node to identify whether to communicate with the UE using reciprocity-based communications or using codebook-based communications in accordance with the reciprocity indicator and a plurality of thresholds.

22. An apparatus for wireless communication at a user equipment (UE), comprising:
one or more memories; and
one or more processors, coupled to the one or more memories, which are configured, individually or in any combination, to cause the UE to:
transmit capability information that indicates a plurality of operating modes supported by the UE, the plurality of operating modes being in accordance with at least one of a location of the UE, a network performance indicator, a power savings indicator, or one or more applications associated with the UE; and
receive, in accordance with transmitting the capability information, configuration information associated with one or more operating modes of the plurality of operating modes supported by the UE.

23. The apparatus of claim 22, wherein the configuration information indicates for the UE to enable the one or more operating modes of the plurality of operating modes supported by the UE.

24. The apparatus of claim 22, wherein the one or more processors are further configured to cause the UE to adjust, in accordance with receiving the configuration information, at least one of an application associated with the UE, a mobility parameter, a radio frequency parameter, a location parameter, or a sensor parameter.

25. The apparatus of claim 22, wherein the one or more processors are further configured to cause the UE to transmit an indication that the UE has activated an operating mode of the one or more operating modes.

26. An apparatus for wireless communication at a network node, comprising:
one or more memories; and
one or more processors, coupled to the one or more memories, which are configured, individually or in any combination, to cause the network node to:
receive capability information that indicates a plurality of operating modes supported by a user equipment (UE), the plurality of operating modes being in accordance with at least one of a location of the UE, a network performance indicator, a power savings indicator, or one or more applications associated with the UE; and
transmit, in accordance with receiving the capability information, configuration information associated with one or more operating modes of the plurality of operating modes supported by the UE.

27. The apparatus of claim 26, wherein the configuration information indicates for the UE to enable the one or more operating modes of the plurality of operating modes supported by the UE.

28. The apparatus of claim 26, wherein the one or more processors are further configured to cause the network node to identify the one or more operating modes of the plurality of operating modes based at least in part on network node capability information.

29. The apparatus of claim 26, wherein the one or more processors are further configured to cause the network node to receive an indication that the UE has activated an operating mode of the one or more operating modes.

30. The apparatus of claim 29, wherein the one or more processors are further configured to cause the network node to transmit a grant indication, a handover indication, or a redirection indication in accordance with receiving the indication that the UE has activated the operating mode.
